(19) United States
(12) Patent Application Publication
(10) Pub. No.: US 2004/0015940 A1
(43) Pub. Date: Jan. 22, 2004

(54) Intelligent device upgrade engine

(75) Inventors: Curtis W. Heisey, Sudbury, MA (US); Ravindra V. Gokhale, Rambaug Colony (IN); Kathy A. Kaminski, Marlborough, MA (US)

Correspondence Address: WEINGARTEN, SCHURGIN, GAGNEBIN & LEBOVICI LLP, TEN POST OFFICE SQUARE, BOSTON, MA, 02109, US

(73) Assignee: 3COM Corporation

(21) Appl. No.: 10/016,597

(22) Filed: Oct. 26, 2001

Related U.S. Application Data
(60) Provisional application No. 60/294,049, filed on May 29, 2001.

(51) Int. Cl. G06F 9/44

(52) U.S. Cl. 717/168; 717/127

(57) ABSTRACT

A tool for replacing a code image in an embedded device including a control program for issuing device commands in order to replace a code image within the embedded device. A monitoring program, operating asynchronously with respect to the control program, generates event indications in response to detecting a change in an attribute associated with the embedded device. The disclosed monitoring program issues device commands and receives event indications. Separate threads of control are used for monitoring and controlling the device being upgraded, and each step of the upgrade process is abstracted as a device independent command. The disclosed system further uses a state machine to keep track of where the device is in the upgrade process.

### CROSS REFERENCE TO RELATED APPLICATIONS

This application claims priority under 35 U.S.C. §119(e) to provisional patent application serial No. 60/294,049 filed May 29, 2001.

### STATEMENT REGARDING FEDERALLY SPONSORED RESEARCH OR DEVELOPMENT

N/A

### BACKGROUND OF THE INVENTION

The present invention relates generally to upgrading of software images in embedded devices, and more specifically to a software tool for replacing code in an embedded device.

As it is generally known, embedded devices are specialized systems contained within another device or system, and which are generally designed to perform a dedicated task. Embedded devices often include one or more microprocessors, as well as a software image that may provide operating system and/or application functionality. The software image for an embedded device is sometimes referred to as the “agent” for that device. Examples of embedded devices include devices located within communication systems such as network switches, routers, or bridges.

From time to time, the software image for an embedded device must be updated (also referred to as an “upgrade”). For example, an update may be needed in order to add new features or to fix bugs in the current image. Moreover, in the present discussion, the terms “update” or “upgrade” are used herein also to refer to software image downgrades, which are also sometimes necessary, and wherein an embedded software image is reverted to a previous version. In many existing systems, software upgrades are performed manually through a command line interface (CLI). However, in a situation in which there are hundreds or even thousands of devices which must be upgraded, such a manual approach is difficult and time consuming.

Some vendors have provided automated upgrade tools to assist in upgrading software images of embedded devices. The part of an automated upgrade tool that actually upgrades the device is sometimes referred to as an “upgrade engine”. Network management applications provide tools to update software agents on switches. These application tools provide a friendly user interface, and an upgrade engine that upgrades the device. The device goes through a series of steps during a software upgrade, referred to as the “upgrade process”, and the upgrade engine must issue commands to the device in order to initiate and control the upgrade process. The upgrade engine must monitor where the device is in the upgrade process, in order to report errors and potentially correct problems that may occur. Some upgrade tools may be incorporated as stand-alone tools, or as part of the device agent. These types of tools also suffer the same deficiencies as those upgrade tools that are integrated into a suite of network management applications.

Existing tools have often been vendor specific, thus providing assistance only on a proprietary and per-manufacturer basis. Moreover, these existing tools cannot easily be extended to support upgrading of newly introduced devices. Additionally, existing upgrade tools have been unreliable in that they sometimes report a successful upgrade status even when a device has not been successfully upgraded. This drawback is especially significant, since an incorrectly performed device upgrade may result in the failure of an entire network.

For the above reasons, it would be desirable to have a system for upgrading the software image of an embedded device which reliably reports the actual upgrade status of the device following a device upgrade operation, and that may be conveniently extended to support the upgrade of new devices.

### BRIEF SUMMARY OF THE INVENTION

In accordance with the present invention, a system for replacing a code image in an embedded device is disclosed. In the system tool, a control program responds to a user command received through a user interface by issuing device commands in order to replace a code image within the embedded device. A monitoring program, operating asynchronously with respect to the control program, generates event indications in response to detecting changes in one or more attribute associated with the embedded device. The monitoring program forwards the event indications to the control program. The disclosed monitoring program further generate a number of device commands to obtain the status of the device.

Separate threads of control are used for monitoring and controlling the device being upgraded, and each step of the upgrade process is abstracted as a device independent “command”. The disclosed system further uses a state machine to keep track of where the device is in the upgrade process. Through use of an extensive state machine in this regard, the disclosed system captures full knowledge of the upgrade process, and offers a completely deterministic solution to the upgrade process. Moreover, the disclosed system operates to properly identify a failed upgrade, so that in the event of an error, proper corrective action can be initiated. Additionally, the disclosed system also provide the advantage of being able to upgrade groups of devices at a time, in addition to the ability to upgrade a single device at a time.

### BRIEF DESCRIPTION OF THE SEVERAL VIEWS OF THE DRAWING

The invention will be more fully understood by reference to the following detailed description of the invention in conjunction with the drawings, of which:

FIG. 1 is a block diagram showing a network manager node coupled via the World Wide Web (WWW) to a switch;

FIG. 2 is a block diagram showing a high level architecture of an agent update tool in the illustrative embodiment;

FIG. 3 is a flow chart showing steps performed in the illustrative embodiment to upgrade a software image on an embedded system;

FIG. 4 shows a UML (Unified Modeling Language) class diagram of the illustrative device upgrade engine;

FIG. 5 is a UML sequence diagram illustrating the relationship between the device being upgraded and the plug-in in which the upgrade engine is embodied in an illustrative embodiment; and

FIG. 6 is a state transition diagram showing state transitions in the illustrative embodiment.

### DETAILED DESCRIPTION OF THE INVENTION

U.S. provisional patent application No. 60/294,049, filed May 29, 2001, and entitled “Intelligent Device Upgrade Engine,” is hereby incorporated herein by reference.

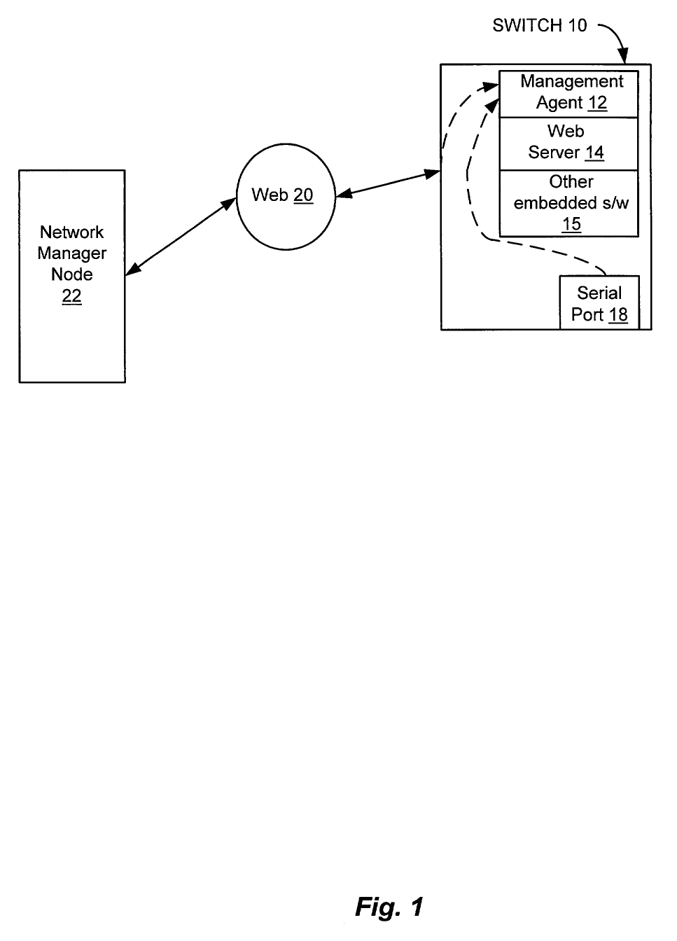

FIG. 1 shows an illustrative embodiment of the disclosed system, including a Switch 10 having a Management Agent 12, Web server 14, and Serial Port 18. The Management Agent 12 and Web server 14 are, for example, software programs contained within a program storage device, such as a memory, located within the Switch 10, and are operable to execute on one or more processors also located within the Switch 10. The Switch 10 may, for example, be any kind of networking device, such as what is generally referred to as a Router, Bridge, or Network Switch. Other embedded software 15, such as device drivers, controllers, and other types of embedded software, may also be included within the Switch 10. The other embedded software 15 may, for example, consist of software in flash RAM (Random Access Memory). While in the illustrative embodiment the embedded device is shown as a management subsystem located within a networking device, the present invention is not limited in application to embedded devices within networking devices, and is applicable to updating embedded software images within any kind of embedded device.

As used herein, the terms “upgrade” and “update” are used interchangeably to denote the changing of a currently loaded software image to a different software image, or simply the reloading of the current software image, within a target embedded device. Such a change in image may be performed for various reasons, including adding functionality, fixing bugs, or any other reason.

The Switch 10 is shown communicably coupled to the World Wide Web 20, which in turn is coupled to a Network Manager Node 22. The Network Manager Node 22 includes an upgrade tool that operates to update software images within the Switch 10, such as the Management Agent 12. The Network Manager Node 22 may, for example, be embodied as a computer system including one or more processors and a computer program storage device, such as a memory, containing a number of programs, including the upgrade tool, executable on that processor or processors.

During operation of the components shown in FIG. 1, the Management Agent 12 operates as a management interface to the outside world for the Switch 10. The Management Agent 12 communicates externally through the Web Server 14 over the World Wide Web 20, and/or through a Command Line Interface (CLI) provided through the Serial Port 18. For example, the Management Agent 12 operates using the SNMP (Simple Network Management Protocol) as a basis for communications over the World Wide Web, however, any other communications protocol may be used in the alternative.

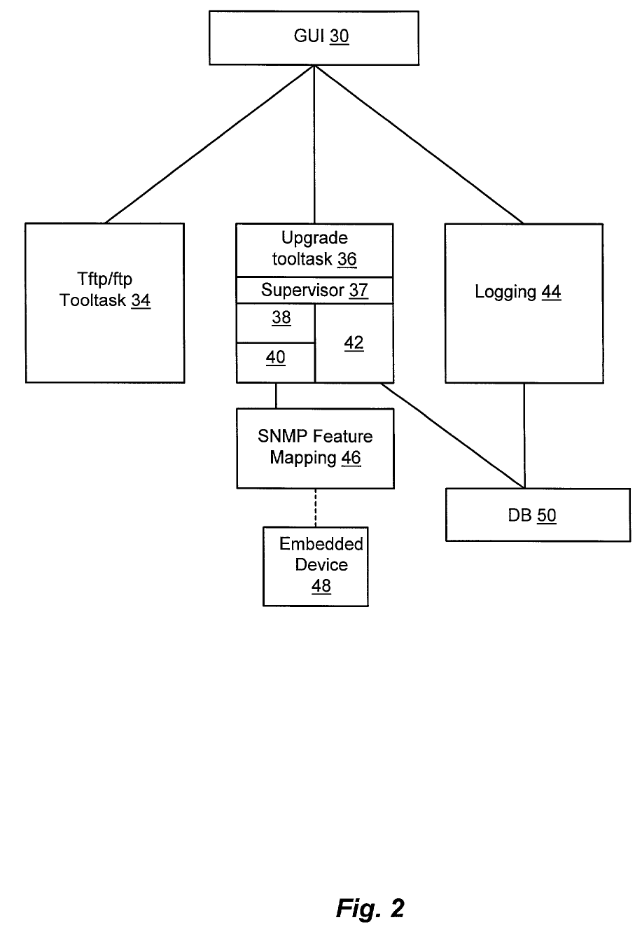

As shown in FIG. 2, in an illustrative embodiment, the disclosed system handles device specific upgrade processes through the use of associated software “plug-ins” having a common interface. As it is generally known, a software plug-in is an auxiliary program that works with another software program to enhance its capability. For example, plug-ins or applets are sometimes added to Web browsers to enable them to support new types of content (audio, video, etc.). In the disclosed system, the plug-ins have the capability to upgrade software agents, firmware, and/or embedded HTTP servers, as well as any other software image on a single target embedded device, or across a family of related embedded devices. Specifically, each such family of devices is associated with a device upgrade plug-in that utilizes a common interface. In one embodiment, a device family is defined as a group of related devices that utilize a common upgrade mechanism, for example, a common upgrade process and a common SNMP (Simple Network Management Protocol) MIB (Management Information Base) for agent file transfers. All device plug-ins have the same external interface.

The disclosed plug-ins utilize a library of device independent, atomic functions that abstract each step in the upgrade process. The disclosed plug-ins employ an abstracted command design pattern, such that multiple commands can be combined together for each specific upgrade mechanism. Accordingly, through use of the disclosed system, all possible steps of all upgrade mechanisms may be covered. For example, command objects for “download file”, “reset device”, and “check version” are provided. A plug-in associated with a given device includes a command list specific to that device composed of these device independent, atomic command objects. One command object is provided for each step in the upgrade process for a particular upgrade mechanism. Each plug-in further includes a device object that abstracts the state of the physical device. This device object executes on its own thread, and sends out events to a supervisor object. The supervisor object includes a state machine that keeps track of where the device is in the upgrade process. Each plug-in is completely hidden from the user, and the use of plug-ins provides extensibility in connection with the disclosed system.

FIG. 2 shows a high level architectural design of an agent update software tool executing on the Network Manager Node 22 of FIG. 1. As shown in FIG. 2, the update related software includes a Graphical User Interface (GUI) 30 for receiving a number of commands, Tftp (Trivial File Transfer Protocol)/FTP (File Transfer Protocol) component 34, an Upgrade Tool task 36 including a Supervisor 37, Plugin-loader 38, one or more Device Upgrade Engine Plugins 40, as well as Agent Version Look-up 42 and Logging component 44. Further shown in FIG. 2 are SNMP support component 46, a Database 50, and the embedded device 48 that is being updated.

During operation of the components shown in FIG. 2, the Upgrade Tool Task 36 organizes and controls all aspects of the actual device upgrade. The Plugin-loader 38 manages the loading and execution of plugins. The Upgrade Tool Task 36 includes a Supervisor object 37 that controls the high level functions associated with agent administration. The Upgrade Tool Task 36 operates to access and maintain the Database 50, which contains locally available versions of software agents that may be used to upgrade embedded devices, as well as mappings of devices to associated update plug-ins. For example, during the upgrade process, the Upgrade Tool Task 36 uses the Database 50 to determine what the latest agent version is for a given embedded device that is to be upgraded. The database 50 may also store information regarding the location of available agent versions, such as pointers to those locally available on the hard disk of the Network Manager Node 22, or to those versions that are stored remotely. Device specific upgrade processes are provided via device specific plug-ins represented in FIG. 2 by the Upgrade Engine plugin 40.

The Logging component 44 operates to log details of device upgrades. Such logged information may be utilized in a variety of ways. For example, following instructional help (such as a “wizard”) that guides a user through an upgrade, a summary screen may be provided that includes information reflecting details of the device upgrade operation that was just attempted. A transaction log record history of device upgrades may also be maintained through the Logging component 44.

The Tftp/ftp Tool Task 34 may, for example, consist of a Tftp server, which may be modified to include the additional ability of collecting information on the number of bytes transferred to a client, and also multithreaded so that it can support multiple simultaneous connections.

The upgrade application illustrated in FIG. 2 handles device specific upgrade processes through the Upgrade Engine Plugin 40. The Upgrade Engine Plug-in 40 includes a device object that abstracts what is actually happening on the physical embedded device that is being upgraded. A state machine is employed that keeps track of where the actual embedded device is within the upgrade process. The device object advances the state machine as the actual embedded device progresses through each step in the upgrade process by issuing events that result in state changes.

FIG. 2 also includes an SNMP feature abstraction object 46, which is used to map abstracted device features to MIB OIDs (“Management Information Base Object Identifiers”). The feature abstraction object 46 may alternatively provide HTTP to feature mapping, or mapping of features to some other control protocol. Such abstracted objects may include, for example, the following items: 1) current agent s/w version, 2) Tftp server address for the agent, 3) download file list for upgrading the agent, and 4) memory location for the download if needed.

At a high level, the disclosed upgrade process consists of a few general steps. In a first step, the several file transfer MIB variables are written on the device agent. This action initiates a file transfer between the SNMP agent and Tftp/ftp server. The server downloads the software image onto the device. In a second step, the device resets, either manually or automatically, and loads the downloaded software image into memory. In a final step, the management host must check the software version of the device in order to verify that the software upgrade was successful. A specific upgrade may actually require several files to be downloaded. In some cases the file or files are transferred as a single set, and in other cases, the files are transferred one-by-one with a reset in between each file transfer. The disclosed upgrade tool handles these as well as other upgrade scenarios.

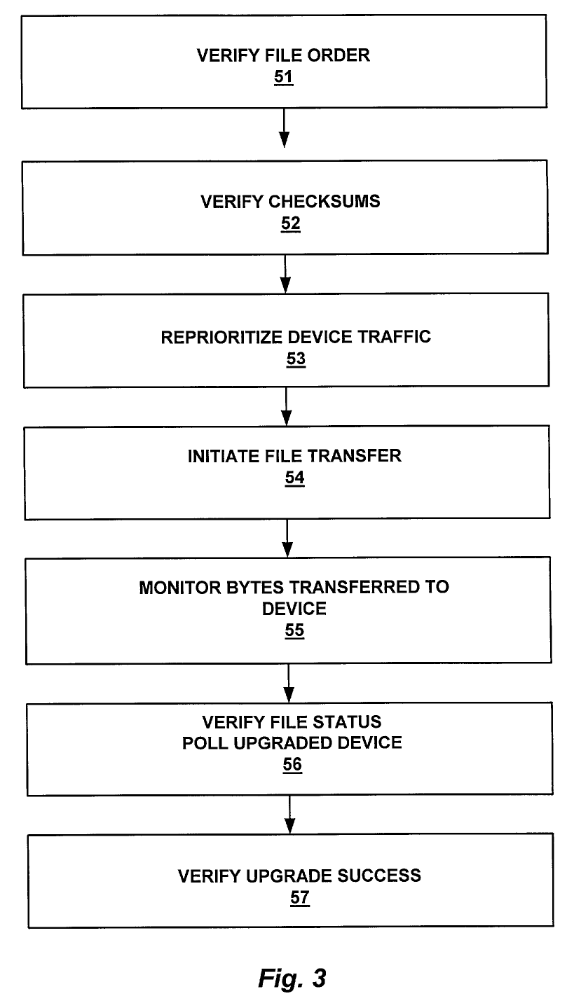

FIG. 3 is a flow chart illustrating a series of specific steps performed by the Upgrade Engine Plugin 40 shown in FIG. 2 while upgrading a software agent for an embedded device. At step 51, the Upgrade Engine Plugin 40 verifies the file order for the upgrade in the case of a multiple file transfer. At step 52, the file checksum(s) is/are verified before any transfers are initiated. Next, at step 53, the Upgrade Plug-In Engine 40 causes the target device to reprioritize traffic in the device so that SNMP (or HTTP) traffic is given highest priority, if such a capability is supported by the device. This allows SNMP status checking and Tftp file transfer traffic to take priority over other device traffic.

At step 54, the Upgrade Engine Plug-in 40 initiates the file transfer to the target embedded device by setting a series of variables in the file transfer MIB. These include the software file name and server IP address associated with the upgrade file or files. In some cases additional variables may be set to specify parameters such as memory location on the device for the transfer. At step 55, the Upgrade Engine Plugin 40 monitors the number of bytes transferred to the device, and reports the total number of bytes that need to be transferred to the Supervisor 37 shown in FIG. 2.

When the file transfer is complete, at step 56, the Upgrade Engine Plug-in 40 verifies the status of the file transfer and polls the upgraded device until it determines that the device has reset, for example by checking one or more objects within the MIB on the device. In cases where the device must be reset manually after loading the image, the upgrade sequence and state machine can be modified by adding a command to reset the device.

At step 57, after the device has reset, the software agent in the device has been upgraded, and the Upgrade Engine Plug-in 40 verifies that the upgrade was successful to the specified version, again by checking one or more MIB objects. In the event of an upgrade failure, the Upgrade Engine Plug-in 40 automatically retries the upgrade. The number of retries is limited so as not to cause an infinite loop.

Through the steps shown in FIG. 3 the Upgrade Engine Plugin 40 upgrades the software in an embedded device. All of the device specific behavior is encapsulated within the Upgrade Engine Plugin 40. A unique version of the Upgrade Engine Plugin 40 may be provided for each embedded device that needs to be upgraded. Embedded devices that share upgrade MIBs as well as upgrade processes (the steps that a device goes through during an upgrade) can be upgraded via the same version of the Upgrade Engine Plugin 40.

The Upgrade Engine Plugin 40 uses a core library of device independent base classes. These are extended for each specific version of the Upgrade Engine Plugin 40. The command library of atomic device independent actions encapsulates each action that is performed with respect to the target embedded device during an upgrade. The commands in this command library can be used by all versions of the Upgrade Engine Plugin 40 without having to make any changes to the command code.

The Update Engine Plugin 40 consists of a control thread and a monitoring thread. As used herein, the term “thread” shall be intended to mean a separate thread of execution within a system that implements multitasking or multiprocessing, such that operations in different threads may take place concurrently. In this way, the individual threads described in the illustrative embodiment are considered to be “asynchronous” with respect to each other.

The control thread within the Update Engine Plugin 40 executes commands that perform the upgrade of the software on the target device, and that verify the status of the upgrade. The monitoring thread monitors what is occurring on the target device and sends information to the control thread by way of events. The device object within the Update Engine Plugin 40 abstracts device behavior and mirrors what is happening on the actual device. All of the communication to and from the device is encapsulated into the device object. Additionally, there is a state machine that keeps track of where the device is in the upgrade process.

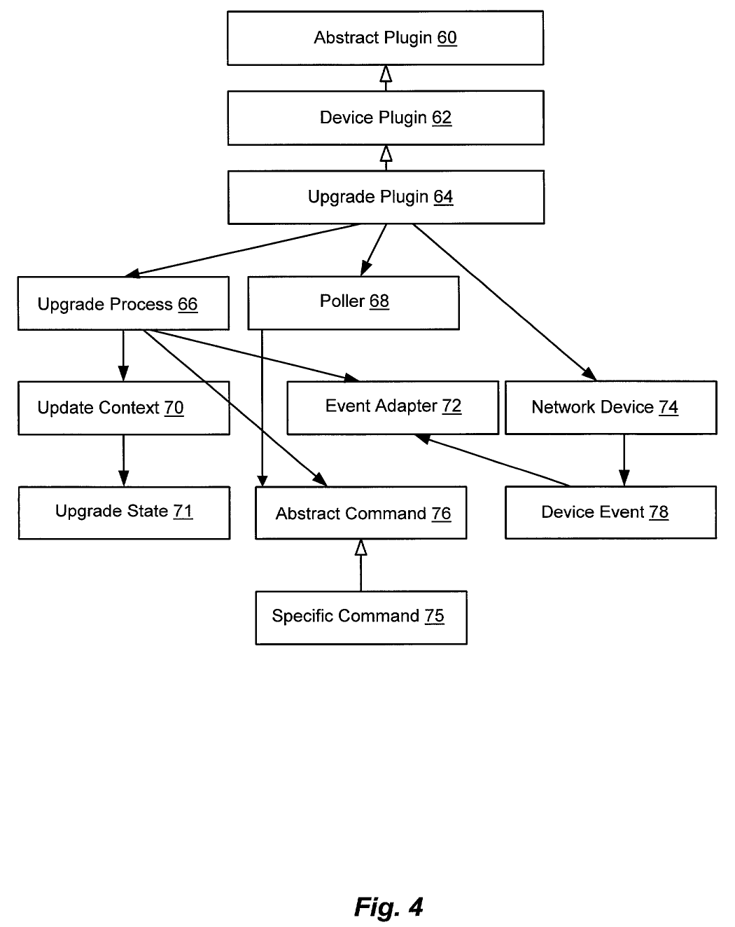

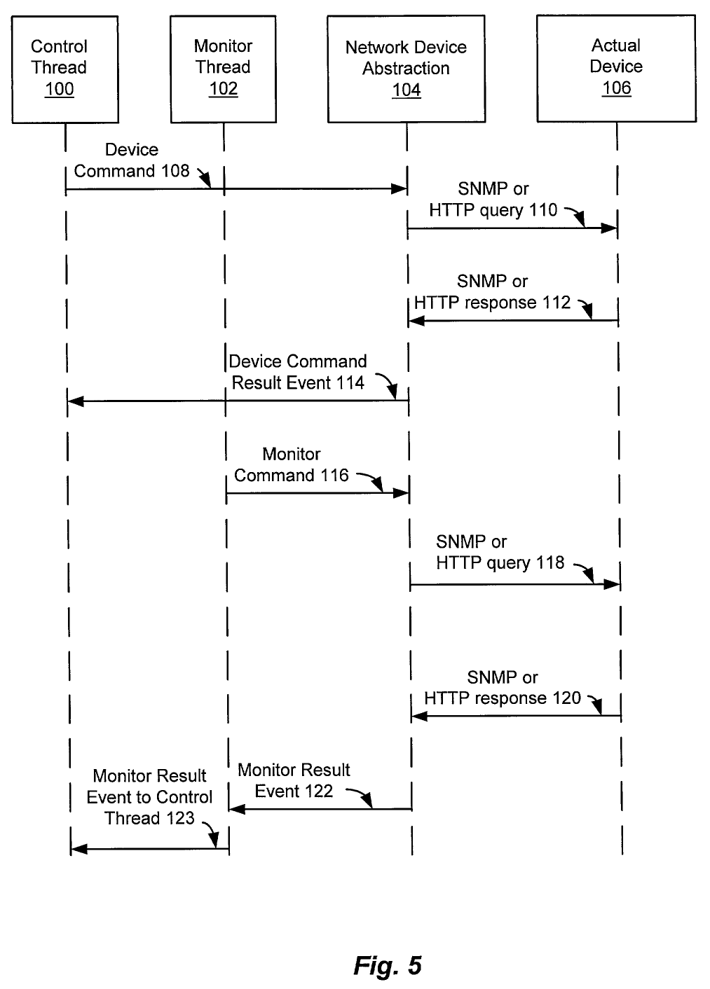

Some key object classes in the illustrative embodiment of the Upgrade Engine Plugin 40 shown in FIG. 4. FIG. 4 is a UML class diagram. Accordingly, lower levels that inherit from higher levels are indicated with a box with an open arrow. Association is indicated with a filled arrow. UML is a common software architecture specification language, described, for example, in “The Unified Modeling Language Reference Manual”, Rumbaugh, Jacobson and Booch, Addison-Wesley, 1999. FIG. 4 is shown including a monitor thread and a control thread. The monitor thread is shown as the Poller class 68, and the control thread is shown as the Upgrade Process class 66. These are the two principal threads in the Update Engine Plugin 40. The monitoring thread operates to track what is occurring on the target device, while the control thread issues commands to the device object to execute each step in the upgrade process. FIG. 5 shows a ladder diagram illustrating in further detail the operation of the control and monitoring threads.

A Device Plugin 62 class updates devices or families of devices. Specifically, there is a unique Device Plugin class 62 for each unique upgrade process, typically related to a device family that shares common upgrade characteristics, such as a common MIB format and similar upgrade process steps. All device plugins have a common interface, shown as Abstract Plugin 60.

The Upgrade Process 66 class contains full knowledge of the steps in the upgrade process for the associated device or family of devices. The Upgrade Process 66 further operates as or contains the control thread. The Command class 76 is the base class from which all commands inherit from. The Device Events 78 class holds the events that are created which describe the results of the commands that are sent to the device during the upgrade process.

The Network Device class 74 is the device abstraction. The Network Device class 74 abstracts all of the device behavior and sends out events. The Network Device 74 class mirrors everything that happens on the device and casts that activity in events. In the illustrative embodiment, all communication, such as SNMP and/or HTTP access to the target device, is encapsulated within the Network Device class 74.

The Event Adapter 72 class takes events from different sources, such as the target device, the Tftp server, and other sources, and converts them into a single event type. This single event type is used by the Upgrade Process class 66 to advance the state machine. There are two categories of operations with regard to dispatching an event. First, there is a default behavior, which is contained in the base class of Event Adapter 72. However, if an event needs to be handled differently than is provided by the base class, then it must be moved to a derived class. A predetermined process in the derived class must call the base method. The Event Adapter 72 further operates to dispatch commands in response to the device events 78 it receives. As shown in FIG. 4, a Specific Command class 75 extends a common base class shown as Abstract Command 76.

The design shown in FIG. 4 makes it possible to provide a “generic” device upgrade plug-in which can be used to update a number of devices sharing certain upgrade-related characteristics. For example, a number of devices that all share the following upgrade-related characteristics may be suitable for such a generic device upgrade plugin:

1) There is a fixed upgrade process and a fixed set of MIB variables to control and monitor the upgrade,

2) Certain SNMP MIB variables, such as the probeConfig SNMP MIB variables, are used to activate the transfer,

3) There is a single agent file for the upgrade,

4) The device uses Tftp for agent file transfer,

5) The device automatically resets (or does not need to be reset),

6) The device is a single unit,

7) The device can be SNMP polled during an upgrade, and

8) Any configurable device parameters are preserved through the upgrade process.

FIG. 5 is a UML Sequence diagram showing interaction between the Control Thread 100, Monitor Thread 102, Network Device Abstraction 104, and Actual Device 106. A Device Command 108 is issued by the Control Thread 100 to the Network Device Abstraction 104. Subsequently, an SNMP or HTTP query 110 is sent by the Network Device Abstraction 104 to the Actual Device 106. After processing the SNMP or HTTP query 110, the Actual Device 106 generates an SNMP or HTTP response 112 to the Network Device Abstraction 104, which in turn generates a Device Command Result Event 114 to the Control Thread 100.

Polling of the device by the Monitor Thread 102 is also illustrated in FIG. 5. In this regard, the Monitor Thread 102 issues a Monitor Command 116 to the Network Device Abstraction 104. The Network Device Abstraction 104 then sends an SNMP or HTTP query 118 to the Actual Device 106, which subsequently sends an SNMP or HTTP response 120 to the Network Device Abstraction 104. As a result, the Network Device Abstraction 104 then sends a Monitor Result Event 122 to the Monitor Thread 102, which in turn provides a Monitor Result Event 123 to the Control Thread 100.

Thus FIG. 5 illustrates how Device Command 108 and Monitor Command 116 create events, shown as Device Command Result Event 114 and Monitor Result Event 122, that specify the result of the commands. Further as shown in FIG. 5, either the control or monitor thread may issue a command. In the illustrative embodiment, the command objects call appropriate helper classes in the Network Device 74 class. The Network Device 74 class forms the SNMP or HTTP queries to the device and processes the result. Note that while SNMP and HTTP are described as possible query types in FIG. 5, any other device communication protocol may be used in the alternative. Additionally, commands are not limited to calling helper functions in the Network Device 74 class. Commands 108 and 116 may also call helper functions in other classes as well. Commands 108 and 116 are based on the command design pattern, and are device independent and atomic in the sense that each command performs a single task.

Further in the illustrative embodiment, commands 108 and 116 are advantageously formed having a common interface. They have a constructor that takes all of the information necessary to create the command. This encapsulates any specific input object in a generic way so that the client of the command does not have to know anything about the operation being requested. Further in the illustrative embodiment, commands have an execute method which performs the command, as well as a stop method which terminates commands that are contained within a separate thread. Some example command classes are shown below. These specific command classes extends a common base class. The derived classes modify a default behavior in the base class with a specific behavior to the command. Using a base class provides a common interface for all specific commands.

| Command Class | Purpose |
|---|---|
| Command | Abstract base class for all |
| | commands. |
| CommandCheckOperational | This command checks to see if |
| | all modules in the device are |
| | operational, as in a stackable |
| | or chassis device. |
| CommandCommunicateDevice | This object determines if the |
| | device can be communicated to. |
| CommandNoOP | This class contains a blank |
| | operation. |
| CommandDeviceReadable | This command verifies that the |
| | device is Readable. |
| CommandDeviceWritable | This command verifies that the |
| | device is writable. |
| CommandFileTransfer | This command initiates file |
| | transfer between the Tftp/ftp |
| | server and the device. |
| CommandInitCheckStatus | This command checks the s/w |
| | version, uptime, and identifies |
| | any device reset. |
| CommandVerifyChecksum | Verifies the file checksum |
| CommandResetDevice | This command resets the device. |
| CommandList | This is a container object that |
| | executes a list of commands. |
| CommandTimeout | This command creates a timeout |
| | event after a specified length |
| | of time. |
| CommandGenerateProgressEvent | This command forces the |
| | progress information to be |
| | computed and generates an event. |
| CommandAutoRetry | This command determines if a |
| | retry of the update is allowed. |
| CommandPrepareDevice | Sets SNMP traffic to maximum |
| | priority |
| CommandBackupConfig | Backs up the device |
| | configuration. |
| CommandRestoreConfig | Restores the configuration |
| | parameters to the device. |
| CommandPrepareDevice | This device prepares the device |
| | for upgrade. |

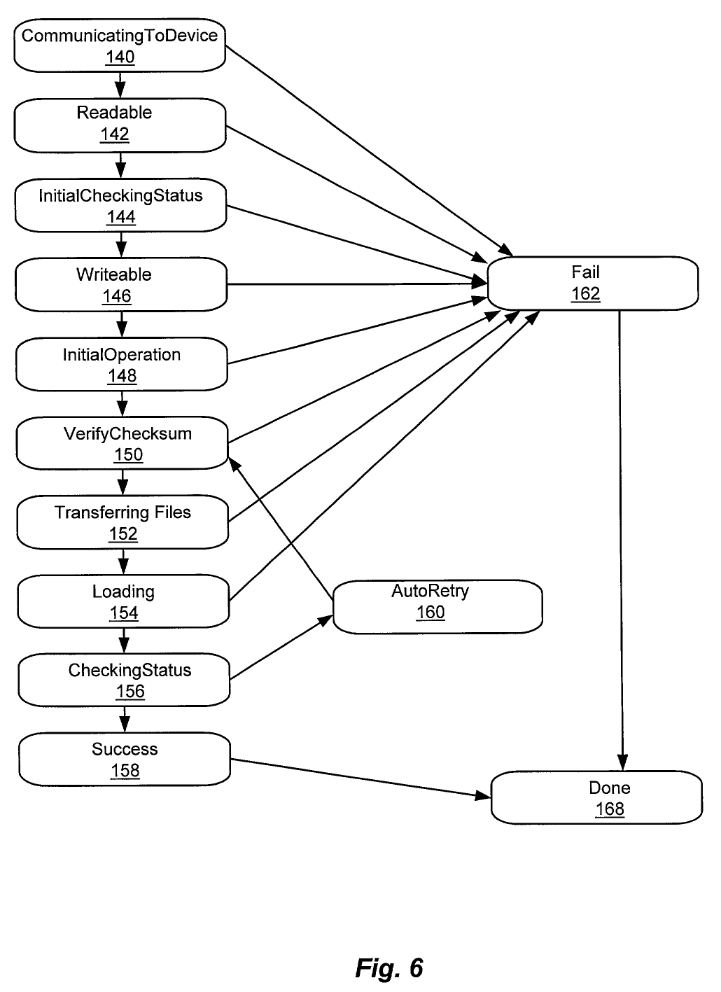

FIG. 6 shows the state machine included in the disclosed system. The state machine of FIG. 6 is maintained within the update context class 70 under the control of the Upgrade Process class 66, as shown in FIG. 4. Also as shown in FIG. 4, the specific state of the upgrade process is maintained in the Upgrade State 71. In the CommunicatingToDevice state 140, the disclosed system determines if the target device is reachable. In the StateReadable state 142, the disclosed system determines if read permissions are correctly set in the target device in order to perform the upgrade. After transitioning to the InitialCheckingStatus state 144, the disclosed system checks to see if the device has already been upgraded. If the check in the InitialCheckingStatus status 144 indicates that the device has not already been upgraded, then in the Writeable state 146, the disclosed system determines if write permissions are correctly set for upgrading on the target device. Next, in the InitialOperation step 148, the disclosed system checks to see if all units in the target device are operational. If so, then the disclosed system verifies the checksum of the image or images to be downloaded to the target device in the VerifyChecksum state 150.

In the TransferringFiles state 152, the disclosed system downloads files to the target device. During the Loading state 154, the target device is in a loading state, during which an executable image may be loaded into the device. The Loading state 154 is normally followed by the CheckingStatus state 156, in which the disclosed system verifies that the upgrade has succeeded. In the case where the upgrade has succeeded, then the CheckingStatus state 156 is followed by the Success state, during which a report of a successful completion may issued to the user. In the case where the disclosed system determines in the CheckingStatus state 156 that the upgrade has not succeeded, then the CheckingStatus state 156 is followed by the AutoRetry state, in which the disclosed system returns to the VerifyChecksum state 150, and proceeds to retry the upgrade.

In the case where the checks and/or other operations performed in the states 140, 142, 144, 146, 148, 150, 152, or 154 fail, the state machine transitions to the Fail state 162, from which one or more failure indications may be provided describing the specific nature of the failure so that appropriate action can be taken. The Success state 158 is followed by termination in the Done state 168. These states can be modified appropriately to accommodate other sequences of steps if the upgrade process is different.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the invention may be embodied in computer software, the functions necessary to implement the invention may alternatively be embodied in part or in whole using hardware components such as Application Specific Integrated Circuits or other hardware, or some combination of hardware components and software.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative data structures, one skilled in the art will recognize that the system may be embodied using a variety of specific data structures. Accordingly, the invention should not be viewed as limited except by the scope and spirit of the appended claims.

What is claimed is:

1. A system for replacing a code image in an embedded device, comprising:
control program code responsive to at least one user command for issuing a plurality of device commands including at least one device command to replace said code image in said embedded device;
monitoring program code, asynchronous with respect to said control program code, for generating at least one event indication in response to a change of at least one predetermined attribute associated with said embedded device and forwarding said at least one event indication to said control program code; and
wherein said at least one device command replaces said code image in response to said at least one event indication.

2. The system of claim 1, wherein said control program code and said monitoring program code are independent threads of execution.

3. The system of claim 1, further comprising a target device abstraction software object, wherein said embedded device abstraction software object generates at least one event to said monitoring program code in response to information obtained from said embedded device.

4. The system of claim 2, wherein said embedded device abstraction software object generates at least one event to said control program code in response to information obtained from said embedded device.

5. The system of claim 4, wherein said information obtained from said embedded device includes at least one value from a Management Information Base (MIB) stored on said embedded device.

6. The system of claim 3, wherein said embedded device abstraction software object further operates to receive said at least one command from said control program code, and, in response to said at least one command from said control program code, send at least one corresponding query to said embedded device.

7. The system of claim 1, wherein said monitoring program code operates to periodically check the state of at least one attribute of said embedded device.

8. The system of claim 8, wherein said monitoring program code operates to periodically check said state of said at least one attribute of said embedded device by sending at least one command to said embedded device abstraction software object.

9. The system of claim 1, further comprising a state machine, wherein said state machine is represented in program code accessible to said control program code.

10. A method for replacing a code image in an embedded device, comprising:
issuing, responsive to at least one user command, a plurality of device commands including at least one device command to replace said code image in said embedded device, wherein said issuing is performed by control program code;
generating, asynchronous with respect to said control program code, at least one event indication in response to a change of at least one predetermined attribute associated with said embedded device and forwarding said at least one event indication to said control program code, wherein said generating is performed by monitoring program code; and
wherein said at least one device command replaces said code image in said embedded device, and wherein said at least one device command is generated responsive to said at least one event indication.

11. The method of claim 10, wherein said at least one event is generated to said monitoring program code by a target device abstraction software object, and wherein said generating of said at least one event by said embedded device abstraction software object is in response to information obtained from said embedded device.

12. The method of claim 11, wherein said generating by said embedded device abstraction software object of said at least one event to said control program code is responsive to obtaining information from said embedded device by said embedded device abstraction software object.

13. The method of claim 12, wherein said obtaining information from said embedded device includes obtaining at least one value from a Management Information Base (MIB) stored on said embedded device.

14. The method of claim 13, further comprising receiving, by said embedded device abstraction software object, said at least one command from said control program code, and, in response to said at least one command from said control program code, sending at least one corresponding query to said embedded device.

15. The method of claim 10, further comprising periodically checking, by said monitoring program code, the state of at least one attribute of said embedded device.

16. The method of claim 15, further comprising, periodically checking, by said monitoring program code, said state of said at least one attribute of said embedded device by sending at least one command to said embedded device abstraction software object.

17. The method of claim 10, further comprising maintaining a current state of said embedded device in a state machine, wherein said state machine is represented in program code accessible to said control program code.

18. A computer program product including a computer readable medium, said computer readable medium having a computer program stored thereon, said computer program for upgrading a software image on an embedded device, said computer program comprising:
control program code for issuing, responsive to at least one user command, a plurality of device commands including at least one device command to replace said code image in said embedded device;
monitoring program code for generating, asynchronous with respect to said control program code, at least one event indication in response to a change of at least one predetermined attribute associated with said embedded device and forwarding said at least one event indication to said control program code; and
wherein said at least one device command replaces said code image in said embedded device, and wherein said at least one device command is generated responsive to said at least one event indication.

19. A system for upgrading a software image on an embedded device, said computer program comprising:
means for controlling an upgrade process, said means for controlling including means for issuing, responsive to at least one user command, a plurality of device commands including at least one device command to replace said code image in said embedded device;
means for monitoring an embedded device, wherein said means for monitoring includes means for generating, asynchronous with respect to said means for controlling, at least one event indication in response to a change of at least one predetermined attribute associated with said embedded device and forwarding said at least one event indication to said control program code; and
wherein said at least one device command replaces said code image in said embedded device, and wherein said at least one device command is generated responsive to said at least one event indication.
